(19) United States
(12) Patent Application Publication
(10) Pub. No.: US 2026/0302078 A1
(43) Pub. Date: Oct. 1, 2026

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventors: Yuji TOMIZAWA, Tokyo (JP); Yasutomo SUGA, Tokyo (JP); Takashi SASAKI, Tokyo (JP)

(73) Assignee: TAIYO YUDEN CO., LTD., Tokyo (JP)

(21) Appl. No.: 19/547,279

(22) Filed: Feb. 23, 2026

(30) Foreign Application Priority Data
Mar. 31, 2025 (JP) 2025-059002

(51) Int. Cl. H01G 4/30; H01G 4/232

(52) U.S. Cl. CPC H01G 4/30; H01G 4/232

(57) ABSTRACT

A multilayer ceramic electronic device includes a capacity section, a first cover layer and a second cover layer sandwiching the capacity section in a first direction, a via electrode that penetrates the capacity section in the first direction, is electrically connected to the plurality of internal electrode layers, has a first end portion located at a boundary between the first cover layer and the capacity section, and has a second end portion exposed from the second cover layer, a small-diameter conductor portion provided in the first cover layer, in contact with the first end portion of the via electrode, and having a width smaller than that of the via electrode in a second direction orthogonal to the first direction, and an external electrode that covers and is electrically connected to at least a portion of the first end portion of the via electrode.

### CROSS-REFERENCE TO RELATED APPLICATION

This application is based upon and claims the benefit of priority of the prior Japanese Patent Application No. 2025-059002, filed on Mar. 31, 2025, the entire contents of which are incorporated herein by reference.

### FIELD

A certain aspect of the present disclosure relates to a multilayer ceramic electronic device and a manufacturing method of the multilayer ceramic electronic device.

### BACKGROUND

In recent years, multilayer ceramic electronic devices such as multilayer ceramic capacitors have been used in a variety of applications. For example, multilayer ceramic electronic devices with as low a height as possible have been developed (see, for example, Japanese Patent Application Publication No. 2005-117004 and Japanese Patent Application Publication No. 2021-13008).

### SUMMARY OF THE INVENTION

According to an aspect of the embodiments, there is provided a multilayer ceramic electronic device including: a capacity section having a plurality of internal electrode layers facing each other and a dielectric layer sandwiched between the plurality of internal electrode layers; a first cover layer and a second cover layer sandwiching the capacity section in a first direction in which the plurality of internal electrode layers face each other; a via electrode that penetrates the capacity section in the first direction, is electrically connected to the plurality of internal electrode layers, has a first end portion located at a boundary between the first cover layer and the capacity section, and has a second end portion exposed from the second cover layer; a small-diameter conductor portion provided in the first cover layer, in contact with the first end portion of the via electrode, and having a width smaller than that of the via electrode in a second direction orthogonal to the first direction; and an external electrode that covers and is electrically connected to at least a portion of the first end portion of the via electrode.

According to another aspect of the embodiments, there is provided a manufacturing method of a multilayer ceramic electronic device including: preparing two first ceramic green sheets and a second ceramic green sheet; forming an internal electrode pattern on the second ceramic green sheet; obtaining a multilayer body by stacking the second ceramic green sheet on one of the two first ceramic green sheets, and then stacking other of the two first ceramic green sheets on the second ceramic green sheet; forming a small diameter via hole in the one of the two first ceramic green sheets using a thermal processing laser, and forming a via hole penetrating the other of the two first ceramic green sheets and the second ceramic green sheet; filling the small diameter via hole and the via hole with a conductor to form a small diameter conductor portion and a via electrode: obtaining an element body by firing the multilayer body; and forming an external electrode electrically connected to the via electrode on the element body.

### BRIEF DESCRIPTION OF THE DRAWINGS

FIG. 1 is a perspective view of a multilayer ceramic capacitor according to an embodiment;

FIG. 2A is a plan view illustrating a first stack unit constituting an element body;

FIG. 2B is a plan view illustrating a second stack unit constituting an element body;

FIG. 2C is a see-through view when a first stack unit and a second stack unit are stacked;

FIG. 3 is a diagram illustrating a multilayer structure of each layer constituting an element body;

FIG. 4 is a cross-sectional view taken along line A-A in FIG. 1;

FIG. 5A to FIG. 5C are diagrams illustrating a recess that occurs when a via holes is formed in an element body before firing;

FIG. 6 is a diagram illustrating effect of an embodiment;

FIG. 7 is a diagram illustrating each size of a first via electrode and a small-diameter conductor portion;

FIG. 8A to FIG. 8C are diagrams illustrating a case where a filler is attached using a film;

FIG. 9A and FIG. 9B are diagrams explaining an extension distance d of a drawn portion;

FIG. 10 is a diagram illustrating a shape of a small-diameter conductor portion;

FIG. 11 is a diagram illustrating a manufacturing process of a multilayer ceramic capacitor;

FIG. 12 is a diagram illustrating a stacking process; and

FIG. 13 is a diagram illustrating a via formation process.

### DETAILED DESCRIPTION

When vias for via electrodes are formed in such low-height products, shrinkage during firing may cause recesses on the non-mounted surface due to the thinness of the low-height product. If a high-temperature and high-humidity test is performed in this state, water will accumulate in the recesses for an extended period of time, causing the various trace additives added to control characteristics to leach out, impairing uniformity within the element and resulting in localized insulation degradation (leakage) and cracks, which may reduce reliability.

Hereinafter, an exemplary embodiment will be described with reference to the accompanying drawings.

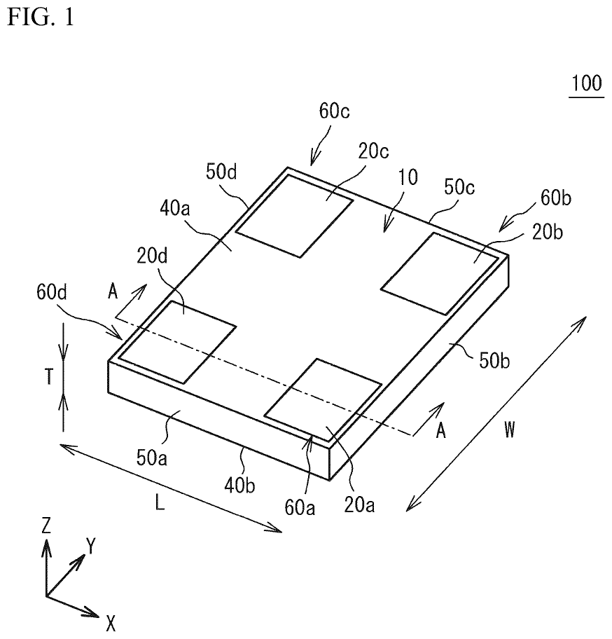

(Embodiment) FIG. 1 is a perspective view of a multilayer ceramic capacitor 100 according to an embodiment. As illustrated in FIG. 1, the multilayer ceramic capacitor 100 includes a substantially flat-plate-shaped element body 10 and four external electrodes (a first external electrode 20a, a second external electrode 20b, a third external electrode 20c, and a fourth external electrode 20d).

The element body 10 includes two main faces, an upper face 40a and a lower face 40b, in the stacking direction. The upper face 40a and the lower face 40b face each other. The element body 10 also includes four other faces, side faces 50a to 50d, in addition to the upper face 40a and the lower face 40b. The side faces 50a and 50c face each other. The side faces 50b and 50d face each other.

The thickness direction of the element body 10, which is the stacking direction of each internal layer, is defined as the Z-axis (first direction). The axis orthogonal to the Z-axis and parallel to the side faces 50a and 50c is defined as the X-axis. The axis orthogonal to the Z-axis and parallel to the side faces 50b and 50d is defined as the Y-axis. The direction orthogonal to the Z-axis direction is sometimes referred to as the second direction. The X-axis, the Y-axis, and the Z-axis are mutually orthogonal. The length of the element body 10 in the X-axis direction is defined as a length L. The width of the element body 10 in the Y-axis direction is defined as a width W. The thickness of the element body 10 in the Z-axis direction is defined as a thickness T. In a plan view from the Z-axis direction, the element body 10 has a substantially rectangular shape. The length L and the width W correspond to the lengths of two adjacent sides of the substantially rectangular shape.

For example, the upper face 40a and the lower face 40b have a substantially square shape in a plan view from the Z-axis direction. The thickness T of the element body 10 in the stacking direction is, for example, 150 μm or less, 120 μm or less, or 90 μm or less. The thickness Tis, for example, 30 μm or more. The length Lis, for example, 1.2 mm, 0.6 mm, 0.5 mm, 0.4 mm, or 0.3 mm. The width W is, for example, 1.2 mm, 0.6 mm, 0.5 mm, 0.4 mm, or 0.3 mm. In this embodiment, the element body 10 has a substantially square shape, but may also have a rectangular shape. The ratio of either the length L or the width W to the height T is approximately 54:46 to 95:5.

The first external electrode 20a is provided on the upper face 40a at a first corner 60a formed by the upper face 40a, the lower face 40b, and the side faces 50a and 50b. The second external electrode 20b is provided on the upper face 40a at a second corner 60b formed by the upper face 40a, the lower face 40b, and the side faces 50b and 50c. The third external electrode 20c is provided on the upper face 40a at a third corner 60c formed by the upper face 40a, the lower face 40b, and the side faces 50c and 50d. The fourth external electrode 20d is provided on the upper face 40a at a fourth corner 60d formed by the upper face 40a, the lower face 40b, and the side faces 50d and 50a. The first external electrode 20a, the second external electrode 20b, the third external electrode 20c, and the fourth external electrode 20d are spaced apart from one another. In this embodiment, the first external electrode 20a, the second external electrode 20b, the third external electrode 20c, and the fourth external electrode 20d each have a substantially rectangular shape in a plan view seen in the Z-axis direction.

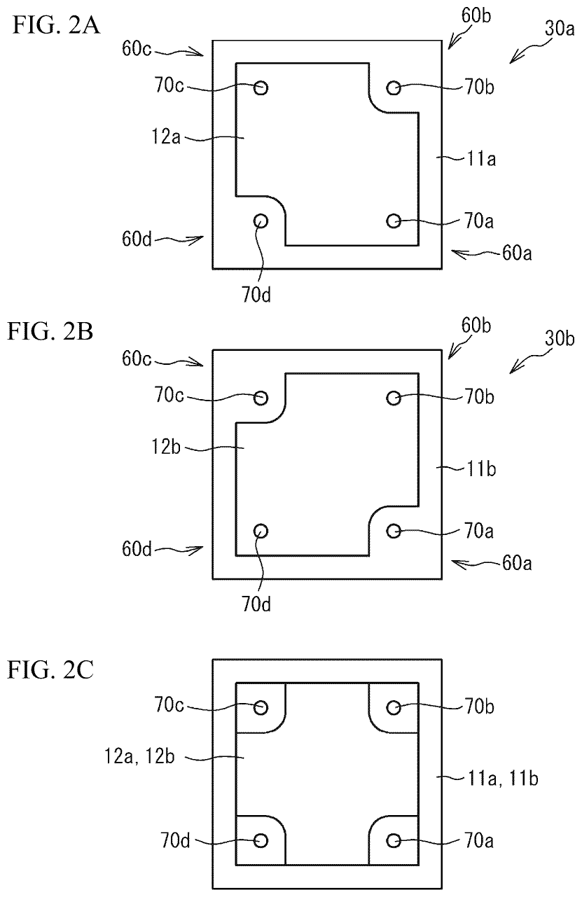

FIG. 2A is a plan view illustrating a first stack unit 30a that constitutes the element body 10. FIG. 2B is a plan view illustrating a second stack unit 30b that constitutes the element body 10. FIG. 2C is a perspective view of the first stack unit 30a and the second stack unit 30b stacked together.

As illustrated in FIG. 2A, in the first stack unit 30a, a first internal electrode layer 12a is stacked on a first dielectric layer 11a. The first dielectric layer 11a has a first via electrode 70a penetrating through the thickness direction at the first corner 60a, a second via electrode 70b penetrating through the thickness direction at the second corner 60b, a third via electrode 70c penetrating through the thickness direction at the third corner 60c, and a fourth via electrode 70d penetrating through the thickness direction at the fourth corner 60d.

The first internal electrode layer 12a extends to the first via electrode 70a and is electrically connected to the first via electrode 70a. The first internal electrode layer 12a does not extend to the second via electrode 70b and is not electrically connected to the second via electrode 70b. The first internal electrode layer 12a extends to the third via electrode 70c and is electrically connected to the third via electrode 70c. The first internal electrode layer 12a does not extend to the fourth via electrode 70d and is not electrically connected to the fourth via electrode 70d. The first via electrode 70a and the third via electrode 70c penetrate the first internal electrode layer 12a in the thickness direction.

Note that, on the first dielectric layer 11a, an inverse pattern having an inverse pattern to that of the first internal electrode layer 12a may be provided around the first internal electrode layer 12a. The inverse pattern is, for example, a dielectric layer that shares the same main ceramic component as the first dielectric layer 11a.

As illustrated in FIG. 2B, in the second stack unit 30b, a second internal electrode layer 12b is stacked on a second dielectric layer 11b. The second dielectric layer 11b has the first via electrode 70a penetrating in the thickness direction at the first corner 60a, the second via electrode 70b penetrating in the thickness direction at the second corner 60b, the third via electrode 70c penetrating in the thickness direction at the third corner 60c, and the fourth via electrode 70d penetrating in the thickness direction at the fourth corner 60d.

The second internal electrode layer 12b does not extend to the first via electrode 70a and is not electrically connected to the first via electrode 70a. The second internal electrode layer 12b extends to the second via electrode 70b and is electrically connected to the second via electrode 70b. The second internal electrode layer 12b does not extend to the third via electrode 70c and is not electrically connected to the third via electrode 70c. The second internal electrode layer 12b extends to the fourth via electrode 70d and is electrically connected to the fourth via electrode 70d. The second via electrode 70b and the fourth via electrode 70d penetrate the second internal electrode layer 12b in the thickness direction.

Note, that, an inverse pattern having an inverse pattern to that of the second internal electrode layer 12b may be provided on the second dielectric layer 11b around the second internal electrode layer 12b. The inverse pattern is, for example, a dielectric layer that shares the same main ceramic component as the second dielectric layer 11b.

As illustrated in FIG. 2C, in a plan view, the contours of the first internal electrode layer 12a and the second internal electrode layer 12b overlap except at the corners. Furthermore, in a plan view, the positions of the first via electrode 70a to the fourth via electrode 70d overlap one another.

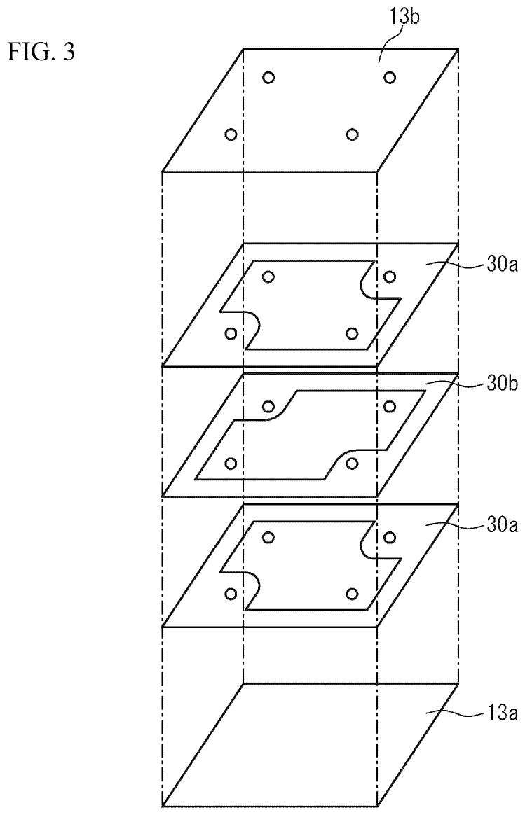

FIG. 3 is a diagram illustrating the multilayer structure of each layer constituting the element body 10. As illustrated in FIG. 3, in the element body 10, the first stack unit 30a illustrated in FIG. 2A and the second stack unit 30b illustrated in FIG. 2B are alternately stacked multiple times. In this embodiment, the multilayer body of the first stack unit 30a and the second stack unit 30b is referred to as a capacity section. A first cover layer 13a is stacked on the lower surface of the capacity section, and a second cover layer 13b is stacked on the upper surface of the capacity section.

With this configuration, the first external electrode 20a and the third external electrode 20c are electrically connected to the first internal electrode layers 12a, and the second external electrode 20b and the fourth external electrode 20d are electrically connected to the second internal electrode layers 12b.

With the above structure, the first external electrode 20a and the third external electrode 20c function as electrodes of a first polarity. The second external electrode 20b and the fourth external electrode 20d function as electrodes of a second polarity. In this embodiment, two diagonally opposite pairs of external electrodes have the same polarity, but the polarities may differ depending on the pattern of the internal electrode layers.

The first internal electrode layer 12a and the second internal electrode layer 12b are primarily composed of metal. For example, the first internal electrode layer 12a and the second internal electrode layer 12b are primarily composed of base metals such as nickel (Ni), copper (Cu), or tin (Sn), or alloys containing at least one of these. The first internal electrode layer 12a and the second internal electrode layer 12b may also be composed of a noble metal such as platinum (Pt), palladium (Pd), silver (Ag), or gold (Au), or alloys containing at least one of these. Ceramic particles may be added to the first internal electrode layer 12a and the second internal electrode layer 12b as a co-material. The thickness of the first internal electrode layer 12a and the second internal electrode layer 12b is, for example, 1.5 μm or less, 1.0 μm or less, or 0.7 μm or less. The thickness of the first internal electrode layer 12a can be measured by observing the cross section of the multilayer ceramic capacitor 100 with a scanning electron microscope (SEM), measuring the thickness at 10 points for each of 10 different first internal electrode layers 12a, and deriving the average value of all the measurement points. The thickness of the second internal electrode layer 12b can be measured using the same method.

A main component of the first via electrode 70a to the fourth via electrode 70d is metal. The material of the first via electrode 70a to the fourth via electrode 70d is not particularly limited as long as it is primarily composed of metal. For example, if the first via electrode 70a to the fourth via electrode 70d are made of the same metal material as the first internal electrode layer 12a and the second internal electrode layer 12b, the magnitude of shrinkage caused by firing during manufacturing of the multilayer ceramic capacitor 100 is uniform, suppressing deformation. Furthermore, the resistivity of the conductive paths of the multilayer ceramic capacitor 100 is uniform, suppressing localized heat generation during use. Ceramic particles may be added to the first via electrode 70a through the fourth via electrode 70d as a co-material.

The first external electrode 20a through the fourth external electrode 20d are not particularly limited as long as they are conductive, but examples include metals such as nickel (Ni), copper (Cu), tin (Sn), palladium (Pd), platinum (Pt), silver (Ag), or gold (Au), alloys containing any of these as a main component, or conductive resins. Alternatively, the first external electrode 20a through the fourth external electrode 20d may have a structure in which a plated layer is formed on a base layer formed by sintering powder of a conductive material.

A main component of the first dielectric layer 11a and the second dielectric layer 11b is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like. For example, the first dielectric layers 11a and the second dielectric layers 11b contain 90 at % or more of the main component ceramic. The thickness of the first dielectric layer 11a and the second dielectric layer 11b is, for example, 3 μm or less, or 1 μm or less. The thickness of the first dielectric layers 11a can be measured by observing a cross section of the multilayer ceramic capacitor 100 with a scanning electron microscope (SEM), measuring the thickness at 10 points for each of the 10 different first dielectric layers 11a, and deriving the average value of all the measurement points. The thickness of the second dielectric layers 11b can be measured by the same method.

A main component of the first cover layer 13a and the second cover layer 13b is a ceramic material. For example, the material of the first cover layer 13a and the second cover layer 13b has the same primary ceramic material as the first dielectric layer 11a and the second dielectric layer 11b.

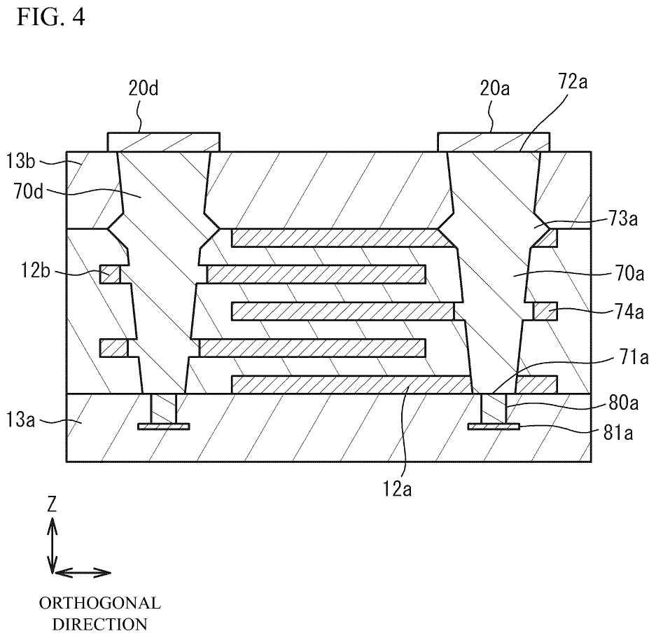

FIG. 4 is a cross-sectional view taken along line A-A in FIG. 1. As illustrated in FIG. 4, the first via electrode 70a penetrates the second cover layer 13b, with a lower first end portion 71a located on the upper face of the first cover layer 13a (at the boundary between the capacitive portion and the first cover layer 13a). An upper second end portion 72a of the first via electrode 70a is exposed from the upper face of the second cover layer 13b. The first external electrode 20a covers at least a portion of the second end portion 72a of the first via electrode 70a and is electrically connected to the first via electrode 70a. The first via electrode 70a is electrically connected to each of the first internal electrode layers 12a at each location in the Z-axis direction.

Furthermore, a small-diameter conductor portion 80a is provided within the first cover layer 13a, contacting the first end portion 71a of the first via electrode 70a and having a width smaller than that of the first end portion 71a in a direction orthogonal to the Z-axis direction. For example, by providing a step with respect to the first end portion 71a of the first via electrode 70a, the small-diameter conductor portion 80a may have a width smaller than that of the first end portion 71a of the first via electrode 70a.

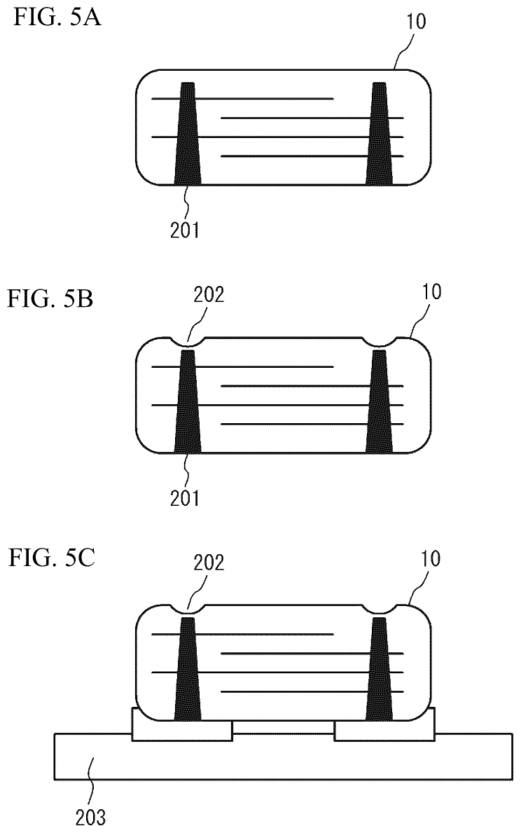

The effects of this embodiment will now be explained. FIG. 5A to FIG. 5C are diagrams illustrating recesses that occur when vias (via holes) are formed in the element body 10 before firing. To provide a via electrode, a via 201 is formed in the element body 10 before firing, as illustrated in FIG. 5A. Because the element body 10 is formed thin before firing, shrinkage that occurs during firing of the element body 10 results in a recess 202 on the surface of the element body 10 near the tip of the via 201, as illustrated in FIG. 5B. When this element body 10 is mounted on a mounting substrate 203 and subjected to a high-temperature, high-humidity test, as illustrated in FIG. 5C, moisture accumulates in the recess 202, causing the various trace additives added for characteristic control to leach out, impairing uniformity within the element body 10 and potentially causing localized insulation degradation (leakage) or cracks, resulting in reduced reliability.

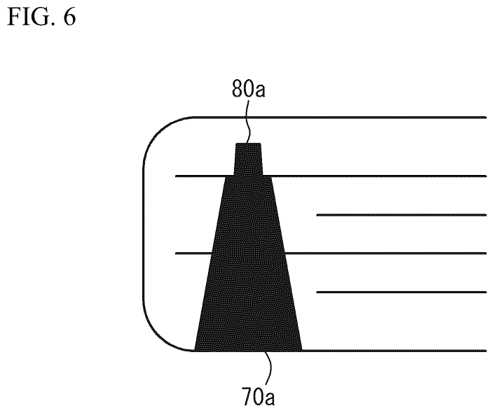

In contrast, because the small-diameter conductor portion 80a has a width smaller than the first via electrode 70a, even if the element body 10 shrinks during firing, the recess 202 in FIG. 5B may be eliminated or reduced in size, as illustrated in FIG. 6. Therefore, even when a high-temperature, high-humidity test is performed, localized pools of water are less likely to form, preventing material elution from within the element body 10, maintaining the uniformity of the element body 10 and preventing a decrease in reliability.

Furthermore, since the first end portion 71a of the first via electrode 70a reaches the upper surface of the first cover layer 13a and the small-diameter conductor portion 80a is further provided from this first end portion 71a within the second cover layer 13b, sufficient electrical connection can be obtained all the way to the lowest first internal electrode layer 12a.

As illustrated in FIG. 4, a flange portion 81a may be formed. The flange portion 81a is located on the first via electrode 70a through the first end portion 71a and the small-diameter conductor portion 80a, and contacts the small-diameter conductor portion 80a and has the width larger than that of the small-diameter conductor portion 80a in a direction orthogonal to the Z axis direction. The provision of the flange portion 81a has the effect of suppressing detachment of the first via electrode 70a during formation. The material of the flange portion 81a is not particularly limited as long as it is conductive, but may be the same material as the small diameter conductor portion 80a, for example.

As illustrated in FIG. 4, in a cross section including the Z-axis direction, the first via electrode 70a may have a tapered shape in which the width gradually increases from the first end portion 71a to the second end portion 72a. The tapered shape of the first via electrode 70a increases the cross-sectional area of the first via electrode 70a in the region near the first external electrode 20a, thereby reducing ESL compared to a straight shape. Furthermore, the via hole on the first end portion 71a side is smaller, which effectively suppresses the recess 202 described in FIG. 5B.

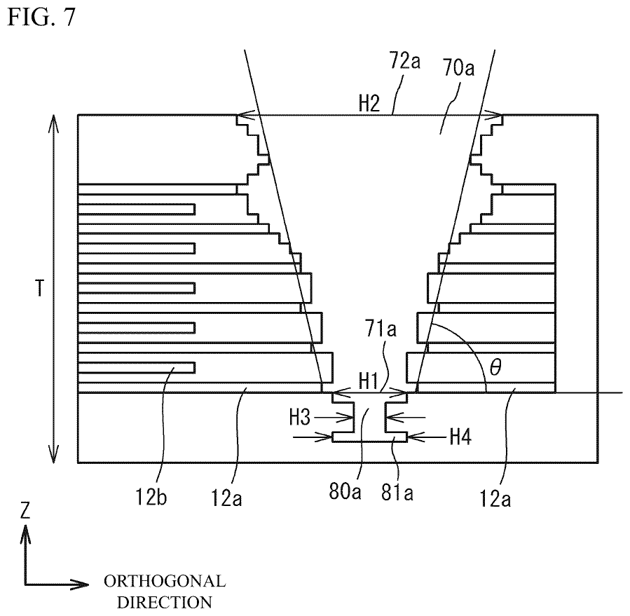

Next, the sizes of the first via electrode 70a and the small-diameter conductor portion 80a will be described in detail. FIG. 7 is a diagram illustrating the sizes of the first via electrode 70a and the small-diameter conductor portion 80a. As illustrated in FIG. 7, a width of the first end portion 71a in the direction orthogonal to the Z-axis direction is referred to as a width H1. A width of the second end portion 72a in the direction orthogonal to the Z-axis direction is referred to as a width H2. A width of the small-diameter conductor portion 80a in the direction orthogonal to the Z-axis direction is referred to as a width H3. A width of the flange portion 81a in the direction orthogonal to the Z-axis direction is referred to as a width H4.

In order to ensure that the width of the small-diameter conductor portion 80a is sufficiently small, it is preferable to set an upper limit to the width H3 of the small-diameter conductor portion 80a. In this embodiment, in the direction orthogonal to the Z-axis direction, the width H3 of the small-diameter conductor portion 80a is preferably 0.8 times or less, more preferably 0.7 times or less, and even more preferably 0.6 times or less, the width H1 of the first end portion 71a of the first via electrode 70a. The width H3 of the small-diameter conductor portion 80a refers to the minimum width of the small-diameter conductor portion 80a.

On the other hand, if the width of the small-diameter conductor portion 80a is too small, the conductor filled during the formation of the first via electrode 70a may be more likely to detach from the via. Therefore, it is preferable to set a lower limit to the width H3 of the small-diameter conductor portion 80a. In this embodiment, in a direction orthogonal to the Z-axis direction, the width H3 of the small diameter conductor portion 80a is preferably 0.2 times or more, more preferably 0.3 times or more, and even more preferably 0.4 times or more, the width H1 of the first end portion 71a of the first via electrode 70a.

If the width H1 of the first end portion 71a of the first via electrode 70a in the direction orthogonal to the Z-axis direction is too small, there is a risk of insufficient connection with the first internal electrode layer 12a. Therefore, it is preferable to set a lower limit on the width H1 of the first end portion 71a of the first via electrode 70a in the direction orthogonal to the Z-axis direction. In this embodiment, the width H1 of the first end portion 71a of the first via electrode 70a in the direction orthogonal to the Z-axis direction is preferably 10 μm or more, more preferably 20 μm or more, and even more preferably 30 μm or more.

On the other hand, if the width H1 of the first end portion 71a of the first via electrode 70a in the direction orthogonal to the Z-axis direction is too large, there is a risk of electrical conduction with the second internal electrode layer 12b, resulting in a short circuit. Therefore, it is preferable to set an upper limit on the width H1 of the first end portion 71a of the first via electrode 70a in the direction orthogonal to the Z-axis direction. In this embodiment, the width H1 of the first end portion 71a of the first via electrode 70a in the direction orthogonal to the Z-axis direction is preferably 100 μm or less, more preferably 80 μm or less, and even more preferably 60 μm or less.

If the width H2 of the second end portion 72a of the first via electrode 70a in the direction orthogonal to the Z-axis direction is too small, the contact area with the signal wiring on the circuit board via the external electrode after mounting on the circuit board may be reduced, or the positioning of the signal wiring and the first via electrode 70a may be misaligned, resulting in a deterioration of ESL. Therefore, it is preferable to set a lower limit for the width H2 of the second end portion 72a of the first via electrode 70a in the direction orthogonal to the Z-axis direction. In this embodiment, the width H2 of the second end portion 72a of the first via electrode 70a in the direction orthogonal to the Z-axis direction is preferably 10 μm or more, more preferably 20 μm or more, and even more preferably 30 μm or more.

On the other hand, if the width H2 of the second end portion 72a of the first via electrode 70a in the direction orthogonal to the Z-axis direction is too large, there is a risk of electrical conduction with the second internal electrode layer 12b, resulting in a short circuit. Therefore, it is preferable to set an upper limit on the width H2 of the second end portion 72a of the first via electrode 70a in the direction orthogonal to the Z-axis direction. In this embodiment, the width H2 of the second end portion 72a of the first via electrode 70a in the direction orthogonal to the Z-axis direction is preferably 100 μm or less, more preferably 90 μm or less, and even more preferably 80 μm or less.

It is also preferable to set upper and lower limits on the ratio (aspect ratio) of the thickness T of the element body 10 to each of the widths H1 to H3. In this embodiment, each of T/H1, T/H2, and T/H3 is preferably 0.5 or more and 15 or less, and more preferably 0.5 ore more and 6 or less.

The width H4 of the flange portion 81a is preferably smaller than the width H2 of the second end portion 72a. If H4 is too large, the capacitance may deviate from the capacitor's desired capacitance.

As illustrated in FIG. 4, the first via electrode 70a may have a large-diameter conductor portion 73a on the second cover layer 13b side in the Z-axis direction, the large-diameter conductor portion 73a having a width greater than the width of the second end portion 72a in a direction orthogonal to the Z-axis direction. Providing the large-diameter conductor portion 73a on the second cover layer 13b side increases the cross-sectional area of the first via electrode 70a in the region closer to the first external electrode 20a, thereby further reducing the ESL. For example, the large-diameter conductor portion 73a is preferably connected to the first internal electrode layers 12a. The provision of the large-diameter conductor portion 73a can prevent the first via electrode 70a from detaching during formation.

If the inclination angle θ of the first via electrode 70a is too small, there is a risk that the conductive material will not remain during formation of the first via electrode 70a. Therefore, it is preferable to set a lower limit for the inclination angle θ of the first via electrode 70a. In this embodiment, the inclination angle θ is preferably 45° or greater, preferably 50° or greater, and preferably 60° or greater.

On the other hand, if the inclination angle θ of the first via electrode 70a is too large, there is a risk that the first via electrode 70a will detach during formation. Therefore, it is preferable to set an upper limit for the inclination angle θ of the first via electrode 70a. In this embodiment, the inclination angle θ is preferably 90° or less, preferably 85° or less, and preferably 80° or less.

The definition of the inclination angle θ will now be explained. As illustrated in FIG. 7, in a cross section including the Z-axis direction, the starting point is the point where the side face of the first via electrode 70a in the second cover layer 13b protrudes most inward. The end point is the end of the lowest internal electrode layer. The line connecting these starting and end points is the inclined line. The line connecting the lowest internal electrode layers is the base line. The angle of the inclined line with respect to this base line is the inclination angle θ.

As illustrated in FIG. 4, the first via electrode 70a preferably has a drawn portion 74a, where at least a portion of the side face is drawn toward the first internal electrode layer 12a. Providing the drawn portion 74a on the first via electrode 70a increases the surface area of the first via electrode 70a, generating friction and preventing detachment of the first via electrode 70a. Incidentally, when the drawn portion 74a is provided, the first via electrode 70a is connected to the first internal electrode layer 12a via the drawn portion 74a.

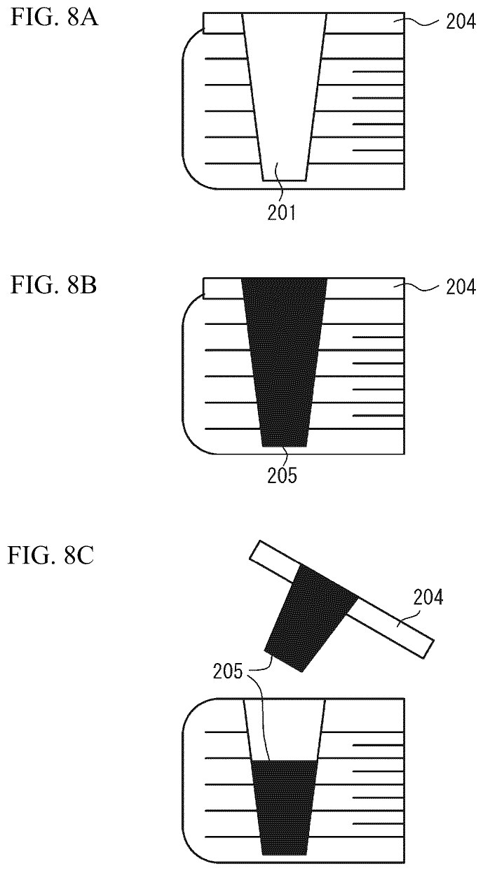

For example, as illustrated in FIG. 8A, the via 201 may be formed in the element 10 before firing, and a film 204 used as a mask may be attached. In this case, as illustrated in FIG. 8B, a filler 205 that will become the first via electrode 70a is filled into the via 201. However, if sufficient friction is not generated between the via 201 and the filler 205, there is a risk that the filler 205 will become detached when the film 204 is peeled off, as illustrated in FIG. 8C. In contrast, providing the drawn portion 74a to generate sufficient friction can prevent the filler 205 from becoming detached.

To fully utilize the effects of the drawn portion 74a, it is preferable to set a lower limit on the extension distance d of the drawn portion 74a. In this embodiment, the extension distance d of the drawn portion 74a is preferably 0.1 μm or greater, more preferably 0.2 μm or greater, and even more preferably 0.3 μm or greater.

If the drawn portion 74a is too long, the multilayer structure of the ceramic green sheet and the internal electrode pattern may collapse or become damaged due to the filling pressure of the conductive material. Therefore, it is preferable to set an upper limit on the length of the drawn portion 74a. In this embodiment, the extension distance d of the drawn portion 74a is preferably 3 μm or less, more preferably 2.5 μm or less, and even more preferably 2.0 μm or less.

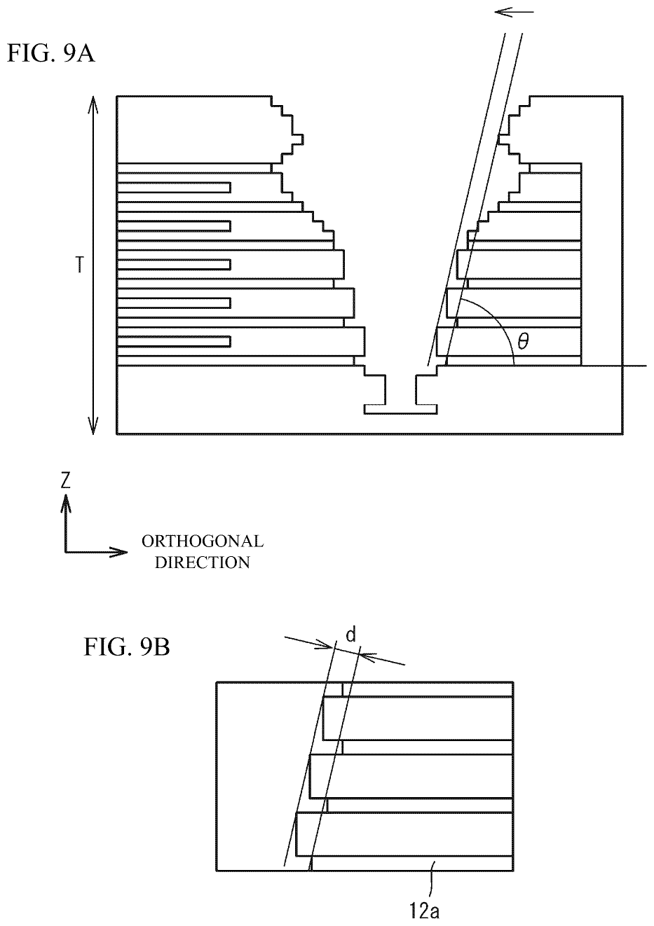

FIG. 9A and FIG. 9B are diagrams for explaining the extension distance d of the drawn portion 74a. As illustrated in FIG. 9A, the inclined line described in FIG. 7 is parallel-translated to the innermost point of the first via electrode 70a. As illustrated in FIG. 7B, the distance from this parallel-translated inclined line to the first internal electrode layer 12a is defined as the extension distance d.

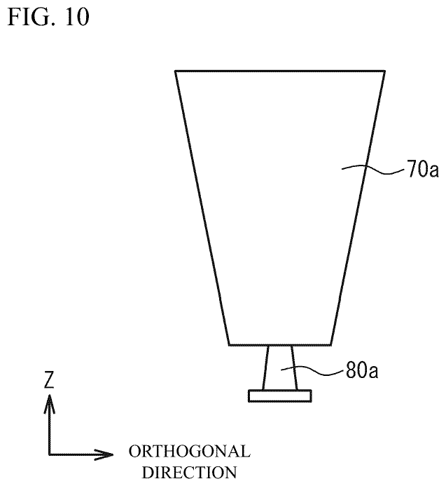

As illustrated in FIG. 10, in a cross section including the Z-axis direction, the small diameter conductor portion 80a may have a tapered shape in which the width thereof gradually increases from the upper surface side to the lower surface side of the second cover layer 13b. That is, the small diameter conductor portion 80a may have a tapered shape that is the opposite of the tapered shape of the first via electrode 70a. The tapered shape of the small diameter conductor portion 80a has the effect of suppressing detachment of the first via electrode 70a during formation.

Note that, in this embodiment, the via electrodes (the first via electrode 70a and the small diameter conductor portion 80a) connected to the first external electrode 20a have been described, but via electrodes with the same structure may also be provided for the second external electrode 20b through fourth external electrode 20d.

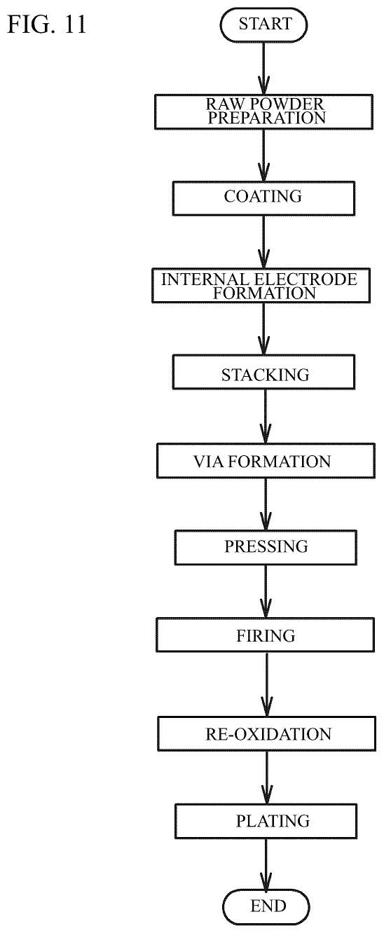

Next, a description will be given of a manufacturing method of the multilayer ceramic capacitors 100. FIG. 11 illustrates a manufacturing method of the multilayer ceramic capacitor 100.

(Preparation process of raw material powder) First, a dielectric material for forming the first dielectric layer 11a and the second dielectric layer 11b is prepared. The A-site element and the B-site element contained in the first dielectric layer 11a and the second dielectric layer 11b are typically contained in the dielectric layers in the form of a sintered body of ABO₃ grains. For example, BaTiO₃ is a tetragonal compound with a perovskite structure and exhibits a high dielectric constant. This BaTiO₃ can generally be obtained by synthesizing barium titanate by reacting a titanium raw material such as titanium dioxide with a barium raw material such as barium carbonate. Various methods have been known for synthesizing the ceramics that constitutes the first dielectric layer 11a and the second dielectric layer 11b, including, for example, a solid-phase method, a sol-gel method, and a hydrothermal method. Any of these methods can be used in this embodiment.

The obtained ceramic powder is added with a predetermined additive compound depending on the purpose. As the additive compound, an oxide of magnesium (Mg), manganese (Mn), vanadium (V), chromium (Cr), a rare earth element (yttrium (Y), samarium (Sm), europium (Eu), gadolinium (Gd), terbium (Tb), dysprosium (Dy), holmium (Ho), erbium (Er), thulium (Tm), or ytterbium (Yb)) or an oxide of cobalt (Co), nickel, lithium (Li), boron (B), sodium (Na), potassium (K) or silicon (Si), or a glass including cobalt, nickel, lithium, boron, sodium, potassium or silicon.

In this embodiment, preferably, a compound containing an additive compound is first mixed with the ceramic particles that will constitute the first dielectric layer 11a and the second dielectric layer 11b, and the mixture is calcined at 820 to 1150° C. The resulting ceramic particles are then wet-mixed with the additive compound, dried, and pulverized to prepare a ceramic powder. For example, the average particle size of the ceramic powder is preferably 50 to 300 nm, from the perspective of thinning the first dielectric layer 11a and the second dielectric layer 11b. For example, the ceramic powder obtained as described above may be pulverized as needed to adjust the particle size, or may be regulated by combining it with a classification process.

(Coating Process) Next, a binder such as polyvinyl butyral (PVB) resin, an organic solvent such as ethanol or toluene, and a plasticizer are added to the resulting dielectric material and wet-mixed. Using the resulting slurry, a ceramic green sheet is applied to a substrate using, for example, a die coater or doctor blade method, and then dried.

A first ceramic green sheet 51 is used as a green sheet for forming the first cover layer 13a and the second cover layer 13b.

(Internal Electrode Formation Process) Either an internal electrode pattern 53a or an internal electrode pattern 53b is formed by printing a metal conductive paste containing an organic binder onto the surface of a second ceramic green sheet 52 using screen printing, gravure printing, or other methods. Ceramic particles are added to the metal conductive paste as a co-material. The main component of the ceramic particles is not particularly limited, but is preferably the same as the main ceramic component of the first dielectric layer 11a and the second dielectric layer 11b. The internal electrode pattern 53a has the shape of the first internal electrode layer 12a described in FIG. 2A. The internal electrode pattern 53b has the shape of the second internal electrode layer 12b described in FIG. 2B.

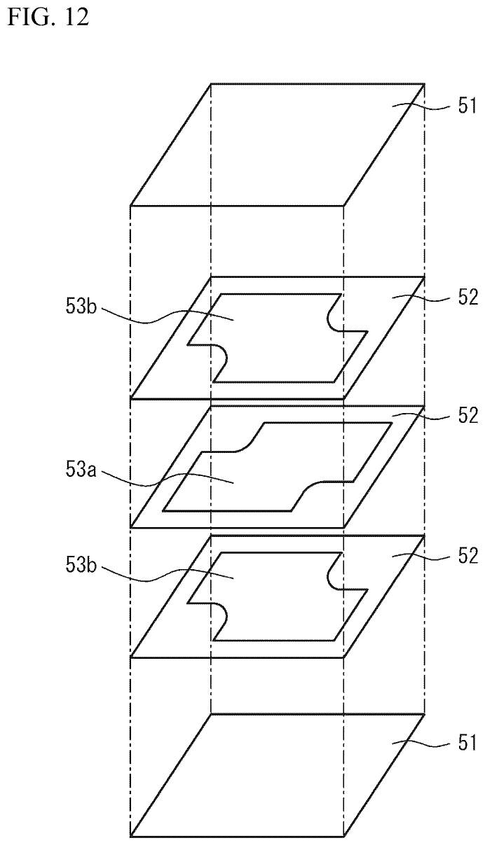

(Stacking Process) As illustrated in FIG. 12, the second ceramic green sheets 52 are stacked on the first ceramic green sheet 51 so that the internal electrode patterns 53a and 53b alternate, and then another first ceramic green sheet 51 is stacked.

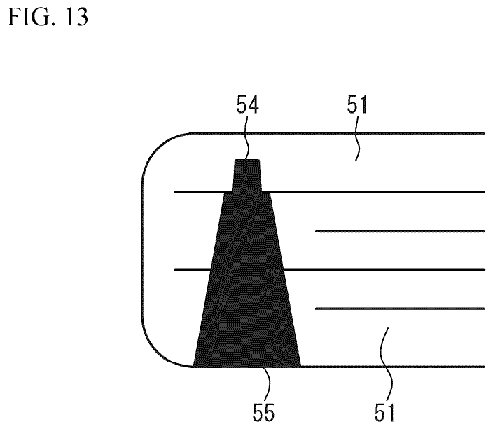

(Via Formation Process) Then, as illustrated in FIG. 13, a thermal processing laser is used to form a small-diameter via 54 in one of the first ceramic green sheets 51, and a via 55 is formed through the other first ceramic green sheet 51 and the second ceramic green sheet 52. The via 55 has a tapered shape. Examples of thermal processing lasers that can be used include a UV laser, CO₂ laser, and YAG laser. When the thermal processing laser switches from processing the ceramic green sheets to processing the internal electrode patterns, the vertical engraving speed slows. Therefore, heat is transferred horizontally, forming the drawn portion 74a. The small-diameter via 54 and the 55 are then filled with a conductor.

(Pressing Process) Then, the first ceramic green sheets 51 and the second ceramic green sheets 52 are pressed and bonded together to obtain a multilayer body. At this time, the small-diameter via 54 has a tapered shape, making it difficult for the conductor to reach the small-diameter via 54 which is a tip portion, resulting in a low conductor density. By pressing the first ceramic green sheets 51 and the second ceramic green sheets 52 together, the small-diameter via 54 is pressed in, reducing their diameters.

(Firing Process) Then, the multilayer body is fired. For example, it is fired at 1100 to 1300° C. for 10 minutes to 2 hours in a reducing atmosphere with an oxygen partial pressure of 10⁻⁷ to 10⁻¹⁰ atm. In this way, the element body 10 is obtained. The conductor in the via 55 becomes the via electrode, and the conductor in the small-diameter vias 54 becomes the small-diameter conductor portion.

(Reoxidation Treatment Process) Subsequently, a reoxidation treatment may be performed in an N₂ gas atmosphere at 600° C. to 1000° C.

(External Electrode Formation Process) Next, a metal paste containing metal filler, glass frit, binder, and solvent is applied by dipping to the areas of the element body 10 where the first external electrode 20a through fourth external electrode 20d will be formed, followed by drying and baking. A plating layer may then be formed by plating.

In addition, the first external electrode 20a through fourth external electrode 20d may be fired simultaneously with the element body 10, and then the plating layer may be formed.

In the above embodiments, a multilayer ceramic capacitor has been described as an example of a multilayer ceramic electronic device, but this is not limiting. For example, other multilayer ceramic electronic devices such as varistors and thermistors may also be used.

### Examples

(Example 1) In Example 1, as described in FIG. 6, a tapered via electrode was provided that penetrated the second cover layer and reached the top surface of the first cover layer, and a small-diameter conductor portion was provided within the second cover layer. This multilayer ceramic capacitor was attached to a glass epoxy substrate (FR4) using cream solder (SMIC; manufactured by Senju Metal Industry Co., Ltd., Eco Solder Paste=M705-GRN-360-K2-V) and then mounted in a reflow oven at 250° C. to 270° C., 0.9 m/min, and in a N₂ atmosphere.

(Comparative Example 1) In Comparative Example 1, the small-diameter conductor portion was not provided. All other conditions were the same as in Example 1.

For each of Example 1 and Comparative Example 1, 1,000 samples were visually inspected using a magnifying glass to determine whether or not they had any recesses before testing. The mounted samples were tested in a reliability test chamber (85° C., 85% humidity) at a voltage of 4V for approximately two hours. After the test, the number of samples with a leakage current value exceeding 100 μA (NG number) was counted. The post-test samples were visually inspected again using a magnifying glass. The results are shown in Table 1.

TABLE 1

| | | NUMBER OF NG | |
|---|---|---|---|
| | | IN HEAT AND | APPERARANCE |
| | RECESS | HUMIDITY TEST | AFTER TEST |
| EXAMPLE 1 | ABSENT | 0/1000 | NO |
| | | | ABNORMALITY |
| COMPARATIVE | PRESENT | 5/1000 | PARTIAL |
| EXAMPLE 1 | | | DISCOLORATION |

As shown in Table 1, discoloration occurred in a portion of each sample in Comparative Example 1. This is believed to be due to the absence of the small-diameter conductor portion, which caused recesses to form during firing. Furthermore, 5 out of 1,000 samples in Comparative Example 1 were judged as NG. This is believed to be due to water collecting in the recess, resulting in the elution of components. In contrast, no discoloration occurred in any of the samples in Example 1. This is believed to be due to the presence of the small-diameter conductor portion, which prevented recesses from forming during firing. Furthermore, none of the 1,000 samples in Example 1 were judged as NG. This is believed to be due to the absence of recesses and the accumulation of water.

(Example 2) In Example 2, a large-diameter conductor portion was provided as illustrated in FIG. 4. All other conditions were the same as in Example 1.

The ESL@100 Hz of the samples of Example 2 and the samples of Comparative Example 1 was measured after mounting on a substrate. The results are shown in Table 2.

TABLE 2

| | ESL@100 Hz |
|---|---|
| EXAMPLE 2 | 20 pH |
| COMPARTIVE | 22 pH |
| EXAMPLE 1 | |

As shown in Table 2, the ESL@100 Hz of Comparative Example 1 was 22 pH. In contrast, the ESL@100 Hz of Example 1 decreased to 20 pH. This is thought to be because the large-diameter conductor portion increased the cross-sectional area of a part of the via electrode.

(Example 3) In Example 3, as illustrated in FIG. 8A to FIG. 8C, a 0.1 mm-thick PET film was attached to the surface of the unfired element body, except for the region where via electrodes would be provided, and via electrodes were formed using a thermal processing laser. By using a thermal processing laser, the drawn portions illustrated in FIG. 4 were formed in the via electrodes. Other conditions were the same as in Example 1.

(Comparative Example 2) In Comparative Example 2, a 0.1 mm thick PET film was attached to the surface of the unfired element body, except for the region where the via electrodes were to be formed, and a non-thermal processing laser was used to form the via electrodes. By using a non-thermal processing laser, drawn portions were not formed in the via electrodes. Furthermore, the small-diameter conductor portions was not formed. Other conditions were the same as in Example 1.

For Example 3 and Comparative Example 2, the vias of 500 samples were filled with electrode paste, and the PET films were then peeled off. After peeling off the PET films, the via filling success was evaluated using transmitted light with a magnifying glass (x20). The results are shown in Table 3.

TABLE 3

| | NUMBER OF NG |
|---|---|
| EXAMPLE 3 | 0/500 |
| COMPARATIVE | 50/100 |
| EXAMPLE 2 | |

As shown in Table 3, in Comparative Example 2, detachment of the conductive paste (NG) was confirmed in 50 of the 500 samples. This is thought to be because the absence of the drawn portion caused no friction, resulting in the conductive paste being detached. In contrast, in Example 3, no detachment of the conductive paste was observed in any of the 500 samples. This is thought to be because the provision of the drawn portion caused friction, preventing the conductive paste from being detached.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
a capacity section having a plurality of internal electrode layers facing each other and a dielectric layer sandwiched between the plurality of internal electrode layers;
a first cover layer and a second cover layer sandwiching the capacity section in a first direction in which the plurality of internal electrode layers face each other;
a via electrode that penetrates the capacity section in the first direction, is electrically connected to the plurality of internal electrode layers, has a first end portion located at a boundary between the first cover layer and the capacity section, and has a second end portion exposed from the second cover layer;
a small-diameter conductor portion provided in the first cover layer, in contact with the first end portion of the via electrode, and having a width smaller than that of the via electrode in a second direction orthogonal to the first direction; and
an external electrode that covers and is electrically connected to at least a portion of the first end portion of the via electrode.

2. The multilayer ceramic electronic device as claimed in claim 1,
wherein the via electrode has a tapered shape in which a width thereof increases from the first end portion to the second end portion in a cross section including the first direction and the second direction, and
wherein the small diameter conductor portion has a step with the via electrode in the second direction, or has a tapered shape in which the width thereof increases from the first end portion toward an opposite side to the second end portion.

3. The multilayer ceramic electronic device as claimed in claim 1,
wherein, in the second direction, the width of the small diameter conductor portion is 0.2 to 0.8 times a width of the first end portion of the via electrode.

4. The multilayer ceramic electronic device as claimed in claim 1,
wherein a diameter of the first end portion of the via electrode is 10 μm or more and 100 μm or less, and a diameter of the second end portion is 10 μm or more and 100 μm or less.

5. The multilayer ceramic electronic device as claimed in claim 1,
wherein a total thickness of the capacity section, the first cover layer, and the second cover layer in the first direction is 30 μm or more and 150 μm or less.

6. The multilayer ceramic electronic device as claimed in claim 1,
wherein the via electrode has a large-diameter conductor portion that is on the second cover layer side in the first direction and has a width greater than a width of the second end portion in the second direction.

7. The multilayer ceramic electronic device as claimed in claim 1,
wherein the via electrode has a drawn portion in which at least a part of a side face is drawn toward at least one of the plurality of internal electrode layers.

8. The multilayer ceramic electronic device as claimed in claim 7,
wherein a distance that the drawn portion is drawn into at least one of the plurality of internal electrode layers is 0.1 μm or more and 3 μm or less.

9. The multilayer ceramic electronic device as claimed in claim 1, further comprising:
a flange portion that is located on the first via electrode through the first end portion and the small-diameter conductor portion, and contacts the small-diameter conductor portion and has a width larger than that of the small-diameter conductor portion in the second direction.

10. A manufacturing method of a multilayer ceramic electronic device comprising:
preparing two first ceramic green sheets and a second ceramic green sheet;
forming an internal electrode pattern on the second ceramic green sheet;
obtaining a multilayer body by stacking the second ceramic green sheet on one of the two first ceramic green sheets, and then stacking other of the two first ceramic green sheets on the second ceramic green sheet;
forming a small diameter via hole in the one of the two first ceramic green sheets using a thermal processing laser, and forming a via hole penetrating the other of the two first ceramic green sheets and the second ceramic green sheet;
filling the small diameter via hole and the via hole with a conductor to form a small diameter conductor portion and a via electrode:
obtaining an element body by firing the multilayer body; and
forming an external electrode electrically connected to the via electrode on the element body.

11. The manufacturing method as claimed in claim 10,
wherein the thermal processing laser is a UV laser, a CO₂ laser, or a YAG laser.
